(19) United States
(12) Patent Application Publication
(10) Pub. No.: US 2013/0228320 A1
(43) Pub. Date: Sep. 5, 2013

(54) Heat Transfer Device For Reducing Heat Inside Vehicles And A Method Of Determining An Optimal Structure Thereof

(71) Applicants: Mohamed Younes El-Saghir Selim, Al-Ain (AE); Rishdia Ali Al-Zeyoudi, Al-Ain (AE); Fatima Mohamed Ali Khassib Al-Kaabi, Al-Ain (AE)

(72) Inventors: Mohamed Younes El-Saghir Selim, Al-Ain (AE); Rishdia Ali Al-Zeyoudi, Al-Ain (AE); Fatima Mohamed Ali Khassib Al-Kaabi, Al-Ain (AE)

(21) Appl. No.: 13/781,302

(22) Filed: Feb. 28, 2013

(30) Foreign Application Priority Data
Mar. 2, 2012 (GB) 1203694.3

(51) Int. Cl. B60H 1/00

(52) U.S. Cl. CPC B60H 1/00507
USPC 165/177

(57) ABSTRACT

A heat transfer device for transferring heat from the passenger compartment of a vehicle to the ambient air outside the vehicle is provided comprising a sealed tube having a proximal end in fluid communication with a distal end, a chamber extending from the proximal end to the distal end, a heat transport fluid and an internal structure configured to allow the heat transport fluid to pass from the distal end to the proximal end. A method of determining an optimal structure of such a heat transfer device is also provided. comprising determining an amount of heat to remove from the vehicle determining an appropriate heat transfer fluid, configuring the internal structure of the at least one sealed tube for maximizing transport of the appropriate heat transport fluid, and determining an optimal number and optimal dimensions of the at least one sealed tube for maximizing heat transfer.

### FIELD OF THE INVENTION

The present invention relates to a heat transfer device for transferring heat from the passenger compartment of a vehicle to the ambient air outside said vehicle and to a method of determining an optimal structure thereof.

### BACKGROUND OF THE INVENTION

The development of the heat pipe originally started with Angier March Perkins who worked initially with the concept of the working fluid only in one phase (he invented the hermetic tube boiler which works on this principle).

Jacob Perkins (descendant of Angier March) invented the Perkins Tube in 1936 and they became widespread for use in locomotive boilers and baking ovens. The Perkins Tube was a system in which a long and twisted tube passed over an evaporator and a condenser, which caused the water within the tube to operate in two phases.

The concept of the modern heat pipe, which relied on a wicking system to transport the liquid against gravity and up to the condenser, was put forward by R. S. Gaugler of the General Motors Corporation. According to his invention in 1944, Gaugler described how his heat pipe would be applied to refrigeration systems. Heat pipe research became popular after that and many industries and labs including Los Alamos, RCA, the Joint Nuclear Research Centre in Italy, began to apply heat pipe technology their fields. By 1969, there was a vast amount of interest on the part of NASA, Hughes, the European Space Agency, and other aircraft companies in regulating the temperature of a spacecraft and how that could be done with the help of heat pipes.

Many research groups and organizations have showed a great interest in heat pipes, for example a research group at National Taiwan University had project which is “Heat pipe for cooling of electronic equipment” the project solve the problem of heat generated by electronic components by using heat pipes having evaporators and condensers. In this traditional technology applied exclusively to electronic components, the working fluid was water. The liquid water absorbs heat from heat source and evaporates in the evaporator. The experimental parameters were different evaporation surfaces, fill ratios of working fluid and input heating powers. The two-phase cooling device has been proved as a promising heat transfer device with higher effective thermal conductivity than over 200 times of copper. However, this device was only applicable to small scale electronic components.

On Jun. 5, 2007 the project “active heat pipes insulted in air conditioning unit can reduce the operation cost by up to 60%” wins ASEAN energy awards—2007 PT. However, this system is an active system and requires energy to operate. In addition, Metroplitan Bayu industry has developed and invented a new air conditioning unit equipped with active heat pipe able to activity control both the temperature and humidity of a room. However, this traditional technology required use of electric heaters or heating coil which is energy consuming.

In our days, people face many problems due to high temperatures, particularly in hot countries such as the Arab Gulf countries. In these countries, the temperature can reach as high as 48° C. in summer. The problem arises when vehicles are parked in open areas for a long period of time, during which, the car is off and thus active cooling devices (such as air-conditioners) are inoperable and/or ineffective and/or result in high energy cost and/or result in decrease of the life time of the battery. The temperature inside the vehicle's passenger compartment can easily exceed the temperature of the ambient air outside the vehicle by 20° C., thus reaching a temperature of 68° C. This results in an amalgam of problems, from the deterioration of the vehicle's internal components to the nuisance of the passengers when they take off. For example, the high temperature inside a vehicle can affect the composite materials, including glass, in terms of life time and/or change of color.

### SUMMARY OF THE INVENTION

Therefore, there is provided a heat transfer device for transferring heat from the passenger compartment of a vehicle to the ambient air outside the vehicle and a method of determining an optimal structure of such a heat transfer device that would overcome the above-mentioned drawbacks.

The present invention is intended to be used for solving the common problem of high temperatures inside the passenger compartment of vehicles using a passive heat transfer device which does not require any source of power.

The present invention can be applied to any vehicle operating in any region, but particularly interesting for use in vehicles operating in hot countries, such as the Arabic Gulf countries, where the temperature inside the passenger compartment can be very high.

Accordingly, an experiment has been carried out for vehicles operating in the United Arab Emirates during summer, and by using thermometers, it was found that the temperature inside the passenger's compartment of a vehicle while the latter is parked in an open area for a long period of time can exceed the outside environment's temperature by 20 degrees Celsius.

One of the objectives of the present invention is to solve these problems by providing a passive heat transfer device having heat pipes to transfer heat from inside the passenger's compartment of a vehicle to outside the vehicle without use of any source of energy.

Another objective of the present invention is to provide a method of determining an optimal structure of such a heat device as a function of the physical characteristics of the vehicle in which the heat transfer device is to be employed, as well as a function of the meteorological characteristics of the region in which such a vehicle is operating.

Therefore, as a first aspect of the invention, there is provided a heat transfer device for transferring heat from the passenger compartment of a vehicle to the ambient air outside the vehicle, the device comprising: a sealed tube having a proximal end in fluid communication with a distal end, a chamber extending from the proximal end to the distal end, a heat transport fluid, gravitationally biased within the proximal end, and an internal structure configured to allow the heat transport fluid to pass from the distal end to the proximal end.

Preferably, the device is configured to enable the heat transport fluid to pass from the distal end to the proximal end under capillary action.

Preferably, the proximal end functions as an evaporator and the distal end functions as a condenser.

Preferably, the tube diameter is at least 6 times greater than the thickness of the internal structure.

Preferably, the diameter of the channel is at least 3 times greater than the thickness of the internal structure.

Preferably, the tube diameter is at least 2 times greater than the diameter of the chamber.

Preferably, the length of the tube is at least 20 times the greater than the tube diameter.

Preferably, the length of the tube is at least 40 times the greater than the chamber diameter.

Preferably, the tube is substantially circular in cross-section, but it can have other forms without departing of the essence of the present invention.

The heat transport fluid can be Diethyl ether (DEE). This would be particularly suitable for countries where the temperature inside the passenger's compartment is above 35° C. The heat transport fluid can be modified to optimize the efficiency of the device, in such a way to take into account the meteorological characteristics of the region where the vehicle is operating.

Preferably, the tube diameter is less than 0.025 m, and the porosity of the internal structure is 0.25 or greater.

As a further aspect of the invention, there is provided a method of determining an optimal structure of a heat transfer device for transferring heat from the passenger compartment of a vehicle to the ambient air outside the vehicle, the vehicle having vehicle physical characteristics and operating in a region having meteorological characteristics, the heat transfer device comprising at least one sealed tube having a proximal end in fluid communication with a distal end, a chamber extending from the proximal end to the distal end, a heat transport fluid gravitationally biased within the proximal end; and an internal structure configured to allow the heat transport fluid to pass from the distal end to the proximal end, the proximal end functioning as an evaporator and the distal end functioning as a condenser, the method comprising:
determining an amount of heat to remove from the vehicle as a function of the vehicle physical characteristics and of the meteorological characteristics of the region;
determining, as a function of the meteorological characteristics, an appropriate heat transfer fluid, the appropriate heat transfer fluid having appropriate thermodynamic properties allowing the appropriate heat transfer fluid to evaporate at a temperature pre-determined as a function of the meteorological characteristics;
configuring the internal structure of the at least one sealed tube, as a function of the appropriate thermodynamic properties, for maximizing transport of the appropriate heat transport fluid; and
determining an optimal number and optimal dimensions of the at least one sealed tube for maximizing heat transfer from the passenger compartment of the vehicle to the ambient air outside the vehicle, as a function of the determined amount of heat to remove, the determined appropriate thermodynamic properties and the configured internal structure.

Preferably, the physical characteristics of the vehicle comprise a body having various components of different material in direct contact with the ambient air, and the determining an amount of heat to remove from the vehicle comprises determining an amount of heat and hot air infiltrated through each one of the various components inside the vehicle.

Preferably, the internal structure has pores and the configuring the internal structure comprises determining an appropriate size of the pores for maximizing transport of the appropriate heat transport fluid between the proximal and distal ends under capillary action.

Preferably, the meteorological characteristics taken into consideration to determine the optimal structure of the device comprise a temperature and a humidity rate of the region where the vehicle is operating.

Preferably, the process of determining optimal dimensions comprises determining an optimal ratio between a diameter of the tube and a thickness of the internal structure.

Preferably, the process of determining optimal dimensions further comprises determining an optimal ratio between a diameter of the channel and a thickness of the internal structure.

Preferably, the process of determining optimal dimensions further comprises determining an optimal ratio between a diameter of the tube and a diameter of the chamber.

Preferably, the process of determining optimal dimensions also comprises determining an optimal ratio between a diameter of the tube and a length of the tube.

Preferably, the process of determining optimal dimensions also comprises determining an optimal ratio between a length of the tube and a diameter of the chamber.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

Further features and advantages of the present invention will become apparent from the following detailed description, taken in combination with the appended drawings, in which:

FIG. 1 is a psychometric chart;

FIG. 2 is a table of factors for sensible heat gain through glass for average applications;

FIG. 3 is a table of transmission gain factors;

FIG. 4 is a perspective view of the heat transfer device showing the thermal resistances of the different components of the device;

FIG. 5 a) is a sectional front view of the heat transfer device showing the physical components of the device;

FIG. 5 b) is a sectional top view of the heat transfer device showing the physical components of the device;

FIG. 6 is a sectional top view of the device showing radial dimensions of the different physical components of the device;

FIG. 7 is a first front view of the device showing the different physical components and illustrating the heat transfer process;

FIG. 8 is a second front view of the device showing the different physical components and illustrating the heat transfer process;

FIG. 9 is a table of different solutions with corresponding thermodynamic properties; and

FIG. 10 is a flow chart illustrating a method of determining an optimal structure of a heat transfer device for transferring heat from the passenger compartment of a vehicle to the ambient air outside the vehicle.

### DETAILED DESCRIPTION OF THE INVENTION

Any effective engineering project should demonstrate a new positive addition to the engineering field, environment and the society. In this section, we will try to show the main differences between the heat pipes, vapor compression refrigerator (VcR) and so the reader can judge which one will serve his need in a better way. Finally the advantages and disadvantages of both systems will be discussed.

VcR mainly consists of four parts: compressor, condenser, expansion valve and evaporator. The energy input to the cycle will go to the compressor producing pressurized vapor that will expose to the hot section (condenser). Since the temperature of the working fluid in the condenser is higher than the temperature outside of the condenser, heat will transfer from the condenser causing the fluid to condense from vapor phase to the liquid phase. The refrigerant then passes through the expansion valve where its pressure and temperature drop considerably letting it to move toward the cold section (evaporator). Since the refrigerant is coming from the valve with low temperature which is mostly less than the temperature of the section being cooled, heat will transfer from the refrigerated section to the refrigerant (i.e. heat is absorbed by the refrigerant) causing it to pass from the liquid or near-liquid state to the vapor state again. After that the refrigerant will go again to compressor to repeat the cycle again.

A heat pipe mainly comprises two parts: a condenser and an evaporator. When applying heat at any point along the surface of the heat pipe causes the liquid at that point to boil and enter into a vapor state. When this happens, the liquid picks up the latent heat of vaporization. Thus, the gas moves to the other end of the pipe; which is exposed to a cooler ambient; and it condenses to gives up the latent heat of vaporization and moves heat from one end to another end of the heat pipe

One of the objectives of the present invention is to reduce the temperature inside the vehicle when parked for a long period of time under the rays of the sun by transferring heat from inside the vehicle to the outside environment (ambient air outside the vehicle). The provided device comprises at least one heat pipes used to transfer heat rapidly from one point to another without (or with minimum) loss of heat.

Detailed Structure of the Heat Transfer Device:

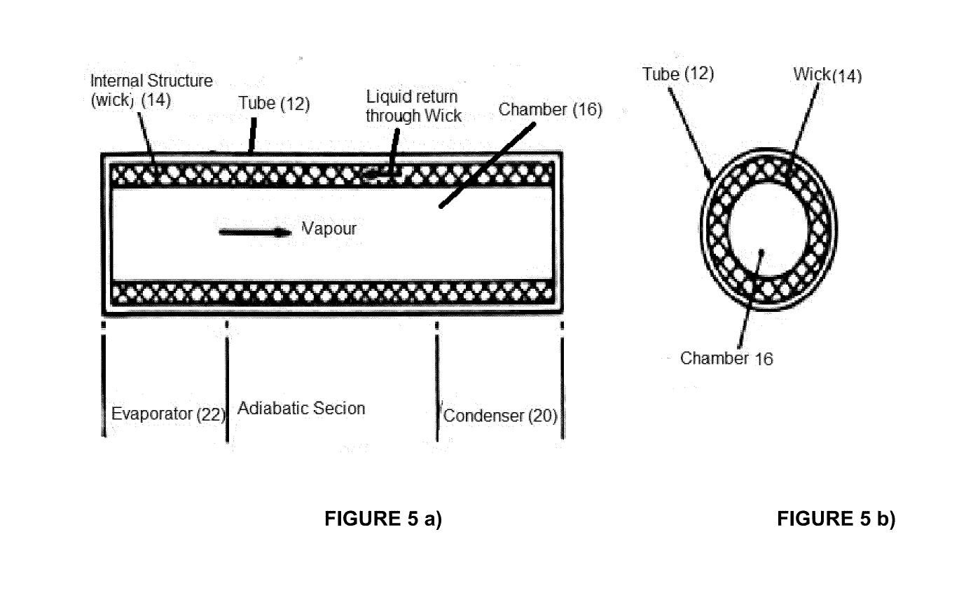

As illustrated in FIGS. 5, 7 and 8, the heat transfer device 10 comprises a sealed tube 12, a heat transport fluid 13, an internal structure 14, and a chamber 16. The sealed tube 12 is preferably made of aluminum or copper and has a proximal end 22 (functioning as an evaporator) in fluid communication with a distal end 20 (functioning as a condenser). The chamber 16 extends from the proximal end 22 to the distal end 20, and the heat transport fluid 13 is gravitationally biased within the proximal end 22 of the sealed tube 12. The internal structure 14 is configured to allow the heat transport fluid 13 to pass from the distal end 22 to the proximal end 20 under capillary action. Preferably, the internal structure 14 has a capillary wicking material, providing the device the ability to transport heat against gravity by an evaporation-condensation cycle with the help of porous capillaries that form the internal structure 14 (also called herein the “wick”).

The internal structure (wick) 14 provides the capillaries a driving force to return the condensed heat transfer fluid (also referred to as “working fluid”) 13 from the distal end (condenser) 20 to the proximal end (evaporator) 22. The quality and type of the internal structure 14 has a direct impact on the performance of the heat transfer device 10. In order to optimize the performance of the device, the internal structure has to be configured in such a way to maximize transport of the heat transport fluid between the proximal and distal ends. One of the main factors that have to be taken into consideration to configure the internal structure 14 is the thermodynamic properties of the heat transfer fluid 13.

For optimizing the performance of the device 10, the heat transport fluid 13 has to be determined, inter alia, as a function of the meteorological characteristics (e.g. temperature and humidity) of the region where the device 10 is to be employed.

The chamber 16 of the sealed tube would contain the heat transport fluid 13 gravitationally biased within the proximal end 22. It has to therefore be leak-proof, maintain the pressure differential across its walls, and enable transfer of heat to take place from and into the heat transfer fluid 13.

An appropriate material of the sealed tube 12 is determined as a function of a certain number of factors, comprising compatibility (with both the heat transfer fluid 13 and the external environment), thermal conductivity, ease of fabrication, and impermeability (it should be non-porous in order to prevent the diversion of the heat transfer fluid 13).

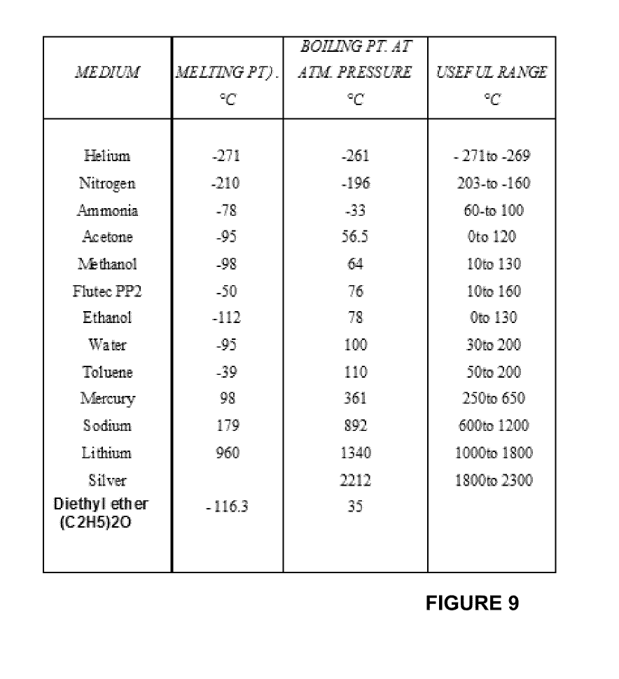

An appropriate heat transfer fluid 13 has to be determined as a function of a certain number of criteria, including the operating vapor temperature range (boiling temperature) which has to be suitable with the meteorological characteristics (mainly the temperature and humidity) of the region where the device is to be employed. FIG. 9 provides thermodynamic properties of a number of solutions, among which can be selected a heat transfer fluid where suitable as a function of criteria.

The appropriate heat transfer fluid 13 has to have the following characteristics: compatibility with the internal structure (wick) 14 and with the material of the sealed tube 12, low liquid and vapor viscosities, high thermal conductivity, vapor pressure not too high or low over the operating temperature range, high surface tension, and good thermal stability.

The selection of the heat transport fluid 13 must also be based on thermodynamic considerations which are concerned with the various limitations to heat flow occurring within the heat transfer device, such as the boiling point of the fluid, the viscosity and the capillary.

For the internal structure (wick) 14, a high surface tension is desirable in order to enable the device 10 to operate against gravity and to generate a high capillary driving force. In addition to high surface tension, it is necessary for the working fluid 13 to wet the wick and the sealed tube material 12 (i.e. contact angle should be zero or very small). The vapor pressure over the operating temperature range must be sufficiently great to avoid high vapor velocities, which would tend to setup large temperature gradient and cause flow instabilities.

The internal structure (wick) 14 is a porous structure. It is preferably made of a high thermo conductive material, such as aluminum, copper, nickel and steel having various ranges of pore sizes.

Fibrous materials, like ceramics, can also be used. They generally have smaller pores. The main disadvantage of ceramic fibers is that, they have little stiffness and usually require a continuous support by a metal mesh. Also, carbon fibers can be used to construe the internal structure (wick) 14. This would also provide for a good heat transport capability.

The prime purpose of the wick 14 is to generate capillary pressure to transport the heat transport fluid 13 from the condenser 20 to the evaporator 22.

The configuration of the internal structure (wick) 14 is to be made as a function of certain factors, several of which are closely linked to the properties of the heat transfer fluid 13.

For example, for countries where the temperature inside vehicles reaches a high range such as 50-60° C. (such as the Arab Gulf countries), an appropriate heat transfer fluid 13 can be Di-ethyl ether (DEE), since the boiling point of said solution is at 35° C. This would be an appropriate heat transfer fluid because the temperature inside the vehicle in summer would reach the range 50-60° C. (or above), which would ensure that the heat transfer fluid will start to absorb heat and boil starting at 35° C.

Thus, the appropriate heat transfer fluid 13 has to be determined as a function of the meteorological characteristics of the region where the device 10 is to be employed. For example, where the device is to be employed in a region having an ambient temperature of 25° C., the appropriate heat transfer fluid should have a boiling point of around that same temperature.

Besides, the heat transfer fluid 13 located inside the chamber 16 of the sealed tube 12 can be replaced, thus allowing the heat transfer device 10 to be adaptable for use in different environments having different meteorological characteristics. For this, the sealed tube can be configured to be unsealed to replace the heat transfer fluid 13. Also, the device can comprise a container (not shown) configured to be detachably connected to the proximal end 22 of the sealed tube 12. The container (not shown) would contain the heat transfer fluid 13 and can be detached to replace the heat transfer fluid 13 whenever necessary.

The heat transfer device 10 containing the heat transfer liquid 13 is placed in such a way that the proximal end (evaporator) 22 is located inside the vehicle—inside the passenger compartment—and the distal end (condenser) 20 is located in the air ambient outside the vehicle. In one experiment, the heat transfer fluid 13 was DEE boiling at 35° C. The high temperature inside the vehicle (above 35° C.) the fluid starts to boil when the temperature inside the vehicle reaches 35° C., and then the heat transfer fluid 13 starts to absorb the heat inside the car and the evaporation process starts. The high pressure inside the sealed tube 12 helps to transfer the heat transfer fluid 13 (in vapor state) from the proximal end 22 to the distal end 20 outside the car. Once the heat transfer fluid 13 (vapor state) reaches the distal end 20, it starts to condense due the lower temperature of the ambient air. The heat transfer fluid 13 is thus condensed and back to the liquid state and is moved to the proximal end 22 by gravitationally force. This process continues (evaporation and condensation) until the temperature inside the vehicle substantially reaches the temperature of the ambient air outside the vehicle.

There are many benefits for the present invention including, protection of the internal components of the vehicle (which would increase life time thereof), energy saving that would have been required by an air conditioner, comfort for passengers.

Determining the Optimal Structure of the Heat Transfer Device:

Cooling load: Cooling load is the total amount of heat energy that must be removed from a system by a cooling mechanism in a unit time, equal to the rate at which heat is generated by people, machinery, and processes, plus the net flow of heat into the system not associated with the cooling machinery.

The cooling load is defined as the amount of heat that must be removed from a car to maintain a comfortable temperature inside the car.

Calculation of cooling load: the cooling load is calculated to determine the structure of the heat transfer device 10 in order to move the necessary amount of heat from inside the vehicle to the ambient air outside the vehicle.

There are two types of cooling loads, knowingly the Sensible cooling load and Latent cooling load.

The sensible cooling load refers to the dry bulb temperature of the car and the latent cooling load refers to the wet bulb temperature of the car.

Factors that influence the amount of the sensible cooling load comprise: glass windows or doors, sunlight striking windows, skylights, or glass doors and heating the room, exterior walls, partitions (that separate spaces of different temperatures), ceilings under an attic, roofs, number of people inside the car, equipment and appliances operated in summer and lights.

Factors that influence the amount of the latent cooling load comprise: moisture (which is introduced into a structure through people, equipment and appliances.

Cooling and Heating Equations:

1) Sensible heat: sensible heat in a heating or cooling process of air that can be expressed as:

Qs=m·Cp·ΔT (1);

\dot{Q}ₜₒₜ is the sensible heat transfer to the air;

cₚ is The specific heat of air in [J/kg.° C.];

ΔT is The average temperature of air at the inlet and the exit of the enclosure[° C.] (Tₒᵤₜ−Tᵢₙ); and

m is the mass in [kg]

2) Latent Heat: latent heat is due to moisture in the air and can be expressed as:

QL=constant·m_{w}·h_{fg} (2)

QL is the latent heat transfer to the air;

hfg is Specific enthalpy of steam;

mw is humidity ratio;

Total Heat—Latent and Sensible Heat;

Total heat (Qt) due to both temperature and moisture can be expressed as;

Qt=Qs+QL=m·Cp·ΔT+constant·mw·h_{fg} (3)

There are some steps should follow it to calculate the cooling load which are that will be illustrated by taking the United Arab Emirates (and the meteorological conditions thereof) as an example:

1) Measuring the temperature of the outside environment (ambient air) and inside the vehicle passenger compartment:

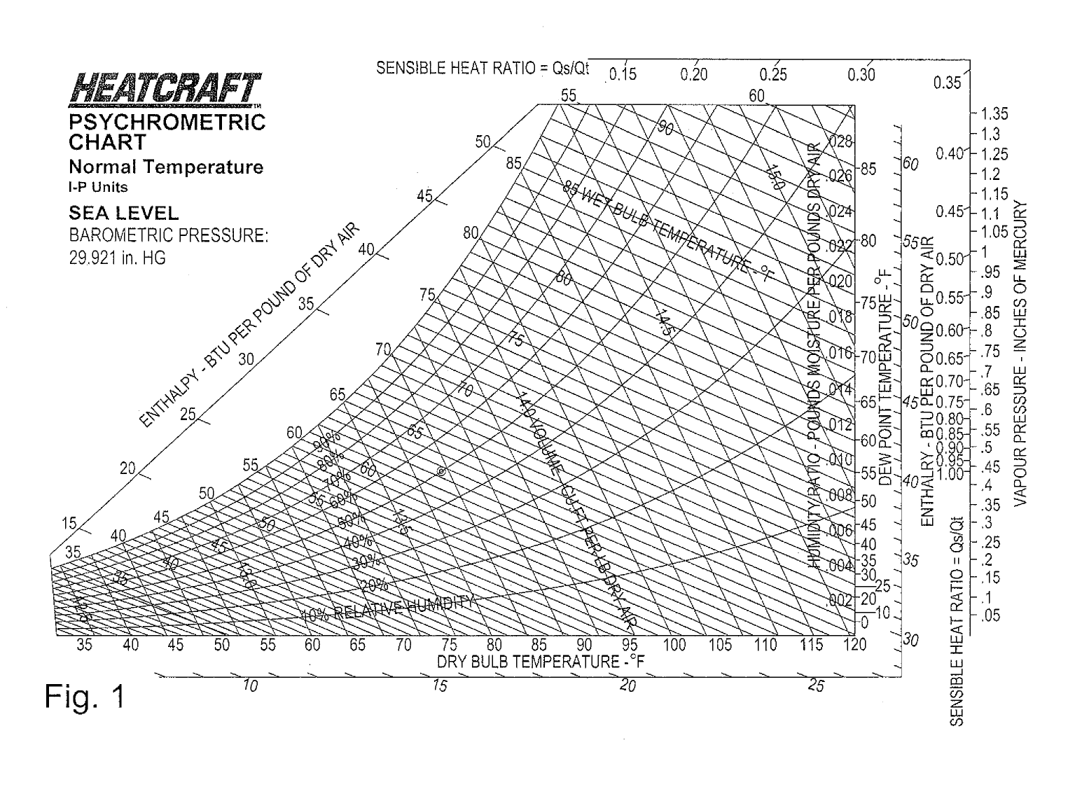

In our example, the first step was choosing the worst condition at summer time in Al-Ain (town in UAE) which is at outdoor temperature is 45° C. and indoor is 65° C., then finding the physical properties from FIG. 1.

TABLE 1
Design Condition

| Design | | | | | |
|---|---|---|---|---|---|
| Conditions: | | | | | |
| DBo(F) = | 117 | Phi | 0.67 | wo(gr/lb) = | 406 |
| DBi(F) = | 77 | Phi | 0.5 | wi(gr/lb) = | 70 |
| DBo-DBi = | 40 | | | wo-wi = | 336 |

DBi(F) is outside temperature in (F) unit, DBo(F) is inside temperature in (F) unit, wo(gr/lb) the humidity of outside air in (gr/lb) and wi(gr/lb) the humidity of inside air in (gr/lb).

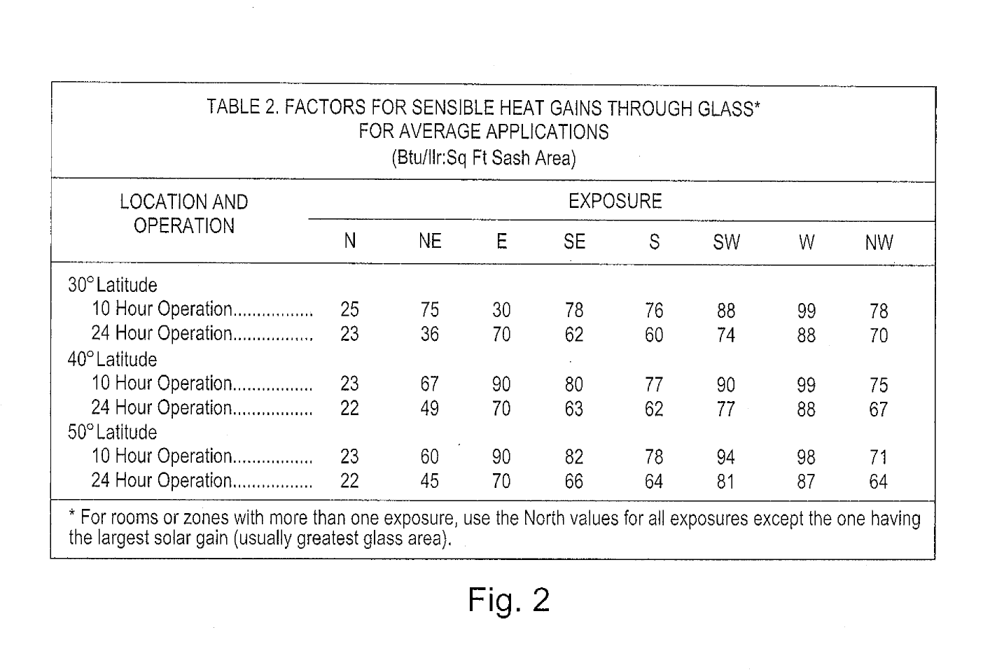

2) Second calculate the sensible heat gain through the glass by using FIG. 2:

The second step is calculating the sensible heat gain through glass which is 3103.873 btu/h as seen in Table 2.

TABLE 2
sensible heat gain

| | A | Unit | S. Factor | Load | Unit |
|---|---|---|---|---|---|
| N | 8.072 | ft² | 25 | 201.8 | BTU/h |
| S | 8.072 | ft² | 76 | 613.472 | BTU/h |
| E | 12.109 | ft² | 90 | 1089.81 | BTU/h |
| W | 12.109 | ft² | 99 | 1198.791 | BTU/h |
| | | | Qstotal = | 3103.873 | BTU/h |

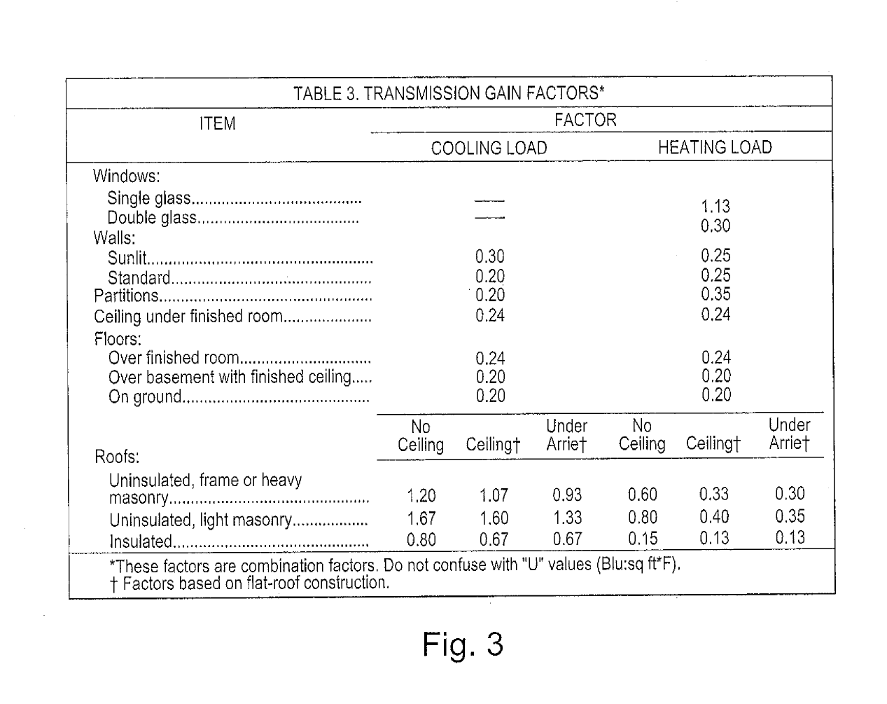

3) Third, ignored the internal heat gain for people, lights and other. The transmission gain at walls, glass, roof and floor taken from FIG. 3 was 2628.4032 Btu/h.

TABLE 3
transmission gain

| | | Unit | | | Unit | | |
|---|---|---|---|---|---|---|---|
| a. walls | A | | Factor | Load | BTU/h | | |
| sunlit | 32.29 | ft² | 0.3 | 387.48 | BTU/h | | |
| | | | Total = | 387.48 | BTU/h | | |
| b. glass | A | | U | Load | | | |
| | 40.362 | ft² | 0.3 | 484.344 | BTU/h | | |
| d. roof | A(ft2) | | Factor | Load | | | |
| | 32.29 | ft² | 1.2 | 1549.92 | BTU/h | | |
| e. floor | A(ft2) | | Factor | Load | BTU/h | | |
| | 21.527 | ft² | 0.24 | 206.6592 | BTU/h | Qstotal = | 2628.4032 |

4) Forth step is calculating the ventilation load and ignore the infiltration air per person and in the invention the infiltration air for space is 0.70628 Btu/h.

TABLE 4
infiltration air for space

| | |
|---|---|
| V(ft3) (volume) | 35.314 |
| factor | 1.2 |
| total CFM | 0.70628 |

50 Final step is calculating the total load of sensible load and latent load which is in the invention 5924 Btu/h. which almost about 0.5 Ton.

TABLE 5
total load

| | Value | Unit |
|---|---|---|
| total sensible load | 5762.7875 | BTU/h |
| total latent load | 161.370854 | BTU/h |
| Total Load | 5924.15835 | BTU/h |
| | 0.49367986 | TON |

By substitute in the different equations to get a final equation which is used to determine the overall length of heat pipes at specific conditions.

By using Bernoulli equation: . . .

$$\frac{P 5}{σ} + \frac{V 5}{2 g} + Z 1 = \frac{P 6}{σ} + \frac{V 6 }{2 g} + Z 2 + {h}_{l} \qquad ( 4 )$$

Because it are at the same level and almost same velocity at two side that is why ignored the velocity and the elevation at each side to get equation (6) And substitute the head lose and the velocity in equations (6,7,8,9,10,11)

| | |
|---|---|
| $\frac{P 5}{σ} + \frac{V 5}{2 g} + Z 1 = \frac{P 6}{σ} + \frac{V 6}{2 g} + Z 2 + {h}_{l}$ | 5 |
| r5 r6 = hₗ | 6 |
| ${h}_{l} = \frac{Δ P}{ρ g}$ | 7 |
| $v = \frac{\dot{m}}{ρ A}$ | 8 |
| $\dot{m} = \frac{Q}{{h}_{fg}}$ | 9 |
| $f \frac{l}{D} \frac{{v}^{2}}{2 y} ρ g = \frac{1}{Z} f \frac{l}{D} ρ \frac{{\dot{m}}^{2}}{{μ}^{2} {A}^{2}}$ | 10 |
| $l = \frac{π {r}^{4} ρ Δ P}{8 μ \dot{m}}$ | 11 |

v is the fluid flow speed at a point on a streamline; g is the acceleration due to gravity; Z is the elevation of the point above a reference plane, with the positive z-direction pointing upward—so in the direction opposite to the gravitational acceleration; P is the pressure at the point; ρ is the density of the fluid at all points in the fluid; \dot{m}ₕ is The mass flow rate of the air in kg/s; L is the length of heat pipe in meter; f is the friction factor of the fluid; μ is the dynamic viscosity in the fluid; and hL is the head loss.

To do the calculation, there are some steps to get the dimensions of the heat pipes which are:

First, take the mechanical properties of liquid and solid at each temperature as seen in Table 6. In this experiment, water was used as a heat transfer fluid, but acetone could also be used as working fluid. As discussed hereinabove, the heat transfer fluid 13 should be determined in such as way that it is suitable for the environment of the country where the heat transfer device 10 is employed. The sealed tube 12 according to this experiment was made of copper but also can made of a different conductive material, such as aluminum and iron.

TABLE 6
the mechanical properties of liquid and solid

| | Value | Unit |
|---|---|---|
| K(copper) | 401 | W/mk) |
| h(evaporation) | 20000 | W/m²k |
| ρ | 1000 | Kg/m³ |
| h(condensation) | 100000 | W/m²k |
| K(working | 0.6 | W/m²k |
| fluid, water) | | |
| hfg | 2270 | kJ/kg |
| μ | 0.000894 | N s/m2 |

k is the thermal conductivity in (W/mk); keff is the effectiveness of thermal conductivity (W/mk); and h is the enthalpy of the system(W/m²k).

The second step is assuming the dimension of the sealed tube, for example the radius, the length of the evaporation section 22 and, the porosity of the internal structure (wick) 14.

TABLE 7
the assumption of Dimension of heat pipe

| | Value | Unit |
|---|---|---|
| r1 | 0.006 | m |
| r2 | 0.01 | m |
| r3 | 0.012 | m |
| Porosity | 0.25 | |
| A(1) | 0.00045 | m² |
| A(2) | 0.00045 | m² |
| D | 0.024 | m |
| L1(length | 0.2 | m |
| of evaporation | | |
| section) | | |

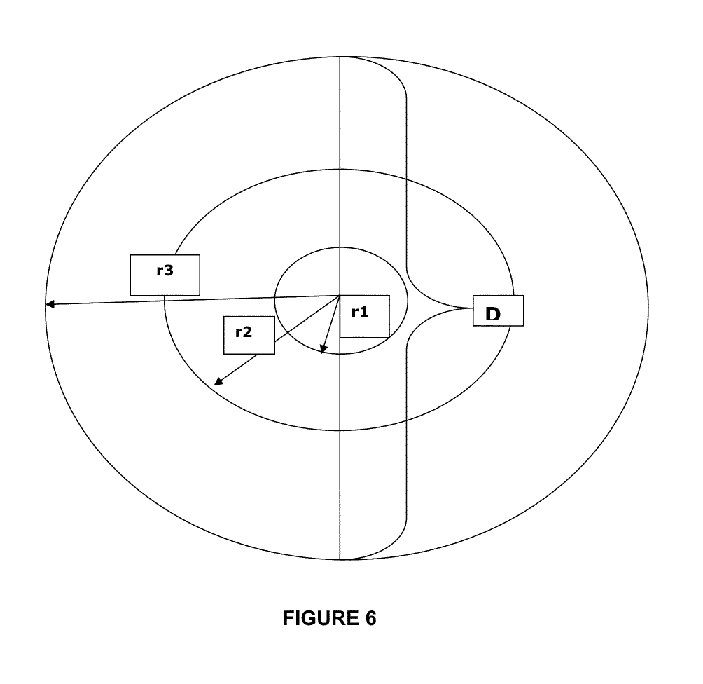

L1 the length of evaporation section, D is the diameter of the tube (heat pipe) 12, and r1, r2, r3 are respectively the radiuses of the chamber 16, the internal structure (wick) 14 and the tube 12 as illustrated in FIG. 6. The porosity of the internal structure 14 is determined by dividing the volume of water that can pour into it by the total volume of the material (here is cotton).

As illustrated, the diameter of the tube 12 is at least 6 times greater than the thickness of the internal structure 14, and it is at least 2 times greater than the diameter of the chamber 16. Besides, the diameter of the chamber 16 is at least 3 times greater than the thickness of the internal structure 14.

Also, the length of the tube 12 is at least 20 times the greater than the diameter of the tube 12, and at least 40 times greater than the diameter of the chamber 16.

Preferably, the tube is substantially circular in cross-section, but it can have other forms.

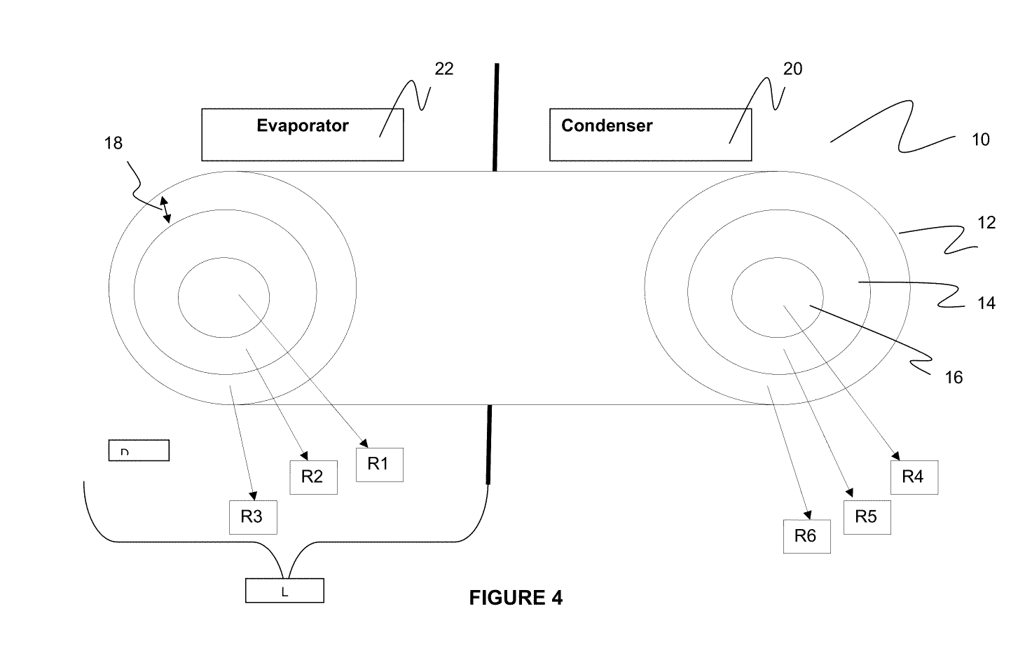

The third step is determining the thermal resistances for each section as illustrated in FIG. 4, by using some principle equations of heat transfer:

TABLE 8
the thermal resistances in each section

| | value | Unit |
|---|---|---|
| R(1,6) | 0.000361813 | ° C./W |
| R(2,5) | 0.001013721 | ° C./W |
| R(3) | 2.26195E−08 | ° C./W |
| R(4) | 0.022104853 | ° C./W |
| R(evap) | 0.023480409 | ° C./W |
| R(cond) | 0.001375556 | ° C./W |

The thermal resistances in the condenser and evaporator are determined by using some equations: R1+R2+R3=R(evap); and R6+R5+R4=R(cond).

The fourth step is determining the temperature difference in each section evaporator and condenser section by using the following equations:

$$\dot{Q} = \frac{Δ T}{R} ; and Δ T = \dot{Q} R$$

By using this equation we substitute the thermal resistances at each sections (evaporator and condenser)) R(evap) and R(cond) to find the (ΔT)1 at evaporator and (ΔT)2 at condenser.

| | Value | Unit |
|---|---|---|
| (ΔT)1 | 41.09 | ° C. |
| (ΔT)2 | 2.407 | ° C. |

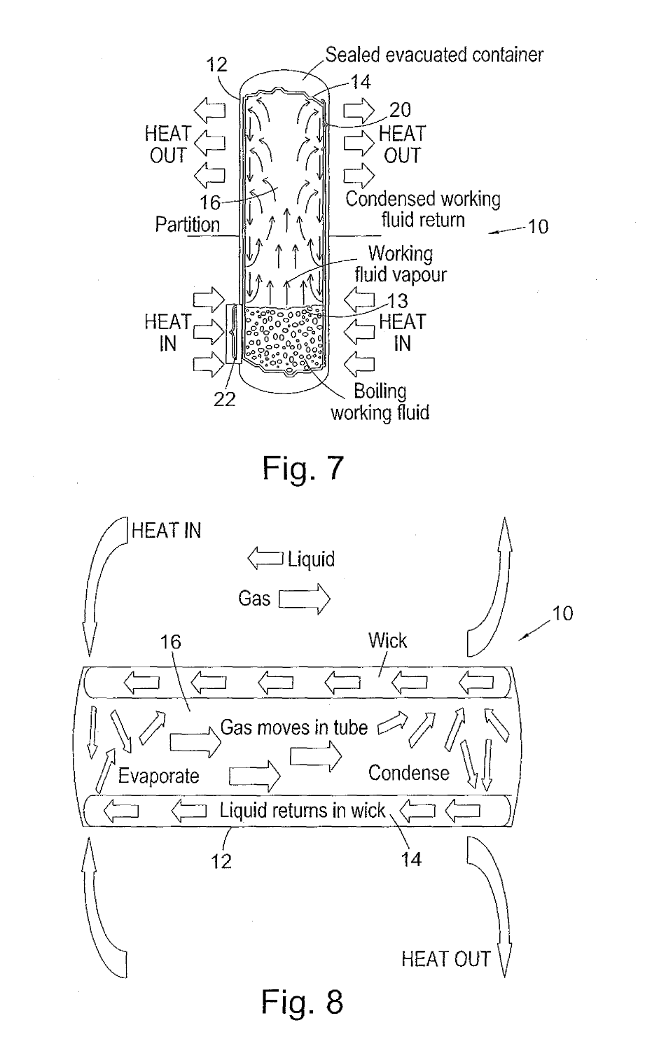

And the temperatures (T1, 12) shown in FIG. 7 are calculated by using the following equations; T1=(ΔT)1−TOUTSIDE and T2=(Δt)2−toutside.

Afterwards, the pressure in the evaporator and the condenser shown in FIG. 7 are determined:

| | |
|---|---|
| F(P4(SAT)) (KPa) | 130.655 |
| F(P5(SAT)) (KPa) | 93.325 |

Finally substitute in equation (7) to find the length of the tube (heat pipe) 12. In this example, the length is about 90 meters. This can be designed by manufacturing 180 tubes (heat pipes) each one having a length of 0.5 meter.

Table 9 summarizes the dimensions of heat pipes that can be installed in the cabinet of a typical car in the United Arab Emirates.

TABLE 9
Dimension of heat pipes

| | Value | Unit |
|---|---|---|
| Number of heat pipes | 180 | |
| Diameter of each heat pipe | 0.024 | meter |
| length of each heat pipe | 0.5 | meter |
| r1 | 0.006 | meter |
| r2 | 0.01 | meter |
| r3 | 0.012 | meter |
| Porosity | 0.25 | |

Sources of heat from outside ambient air to vehicle's interior: Heat transfer by conduction/convection through glass: Heat transfer by conduction/convection through vehicle's body: Direct solar radiation through glass: and Infiltration air through vehicle's leaks.

1. Load due to heat transmission through glass: Cooling Load [BTU/hr]=Area×factor×Temperature Difference; for glass materials, transmission gain factor=1.13 (BTU/hr·ft2·F); Area=Area of glass in the vehicle (front-back-side windows); Temperature Difference=difference between ambient temperature outside (say 113 F (45 C)) and vehicle's interior (say 95 F (35 C)) in Fahrenheit scale.

2. Load due to heat transmission through vehicle's body: Cooling Load [BTU/hr]=Area×U-factor×Temperature Difference; For vehicle' body materials, transmission gain factor=0.3 (BTU/hr·ft2·F); Area=External area of vehicle (excluding glass); and Temperature Difference=difference between ambient temperature outside (say 113 F (45 C) and vehicle's interior (say 95 F (35 C)) in Fahrenheit scale.

3. Load due to heat transmission through vehicle's body: Cooling Load [BTU/hr]=Glass area×Solar factor; For UAE, solar factor=60 (BTU/hr·ft2) (average of all solar directions); Area=Area of vehicle's glass.

4. Load due to infiltration of hot air through vehicle's body: 4-a) Cooling Load (Sensible load), [BTU/hr]=Volume of air infiltrated×Temperature Difference×1.08: 4-b) Cooling Load (latent load), [BTU/hr]=Volume of air infiltrated×Absolute Humidity Difference×0.68

Where, Volume of air infiltrated=Volume of vehicle's cabinet×Air Change per Hour; Air Change per Hour=1; Temperature Difference=difference between ambient temperature outside (say 45 C) and vehicle's interior (say 35 C) in Fahrenheit scale; and Absolute Humidity Difference=difference between ambient outside air absolute humidity (say 45 C conditions−worst case) and vehicle's interior (say at 35 C acceptable conditions) in Grains/pound scale.

Overall Cooling Load, [BTU/hr]=Load 1+Load 2+Load 3+Load4-a+Load 4-b

Total Cooling Load=Overall Cooling Load x safety factor of 1.1, (inclusion of 10% extra heat in case of error in calculations).

For typical Vehicle in the UAE; the overall cooling load (amount of heat to be removed from the vehicle cabinet)≈1.75 kilo Watt (kW), or 0.5 TON of Refrigeration.

CALCULATION OF HEAT PIPE DIMENSIONS; Q (gained by vehicle)=Q (removed by heat pipes' evaporator);

$$\dot{Q} ( Evaporator ) = m \times {h}_{fg} \times ( \frac{1}{time} ) ;$$

### Where

$$m = ρ \times [ ( \frac{π}{4} ) \times {d}^{2} \times l \times filling ratio ] : \\ \dot{Q} ( Evaporator ) = ρ \times [ ( \frac{π}{4} ) \times {d}^{2} \times l \times filling ratio ] \times {h}_{fg} \times ( \frac{1}{time} ) :$$

### So:

$$l = \frac{\dot{Q}}{ρ \times [ ( \frac{π}{4} ) \times {d}^{2} \times filling ratio \times {h}_{fg} \times ( \frac{1}{time} ) ]}$$

m=mass of liquid evaporated inside the heat pipes; p=density of liquid (kg/m³): d=diameter of pipe (m): I=overall length of heat pipes used to remove the heat: filling ratio=percentage of filling of pipe=volume of liquid inside pipe/volume of all pipe: h_{fg}=later heat of evaporation J/kg; time=time of liquid evaporation (assumed here).

The filling ratio was assumed to be 10%, time to be 10 sec and the standard ASME diameter (d) was taken for the copper heat pipe to be 0.75 in. Finally the total length of the heat pipe was calculated in order to find the number of heat pipes required.

TABLE 10
Properties of heat transfer fluid

| Proposed | | | | | |
|---|---|---|---|---|---|
| Fluid | | | | | |
| Properties | | | | | |
| (suitable for | Boiling | | | Total | # of |
| UAE | Temperature | ρ (kg/ | h_{fg} | length | pipes |
| weather) | (C.) | m³) | (j/kg) | (cm) | each 30 cm |
| (1) Diethyl | 34.5 | 713.40 | 376.812 | 297.042 | 9.901 |
| ether | | | | | (say 10) |
| (2) Acetone | 56 | 790 | 544.284 | 185.705 | 6.190 |
| | | | | | (say 7) |

Brief Summary for Determining the Optimal Structure/Dimensions of a Heat Transfer Device:

(I) Calculation of the Cooling Load (Amount of Heat to be Removed from the Vehicle)

Sources of heat from outside ambient air to vehicle's interior: (a) heat transfer by conduction/convection through glass, (2) heat transfer by conduction/convection through vehicle's body, (3) direct solar radiation through glass, (4) infiltration air through vehicle's leaks.

(1) Load due to heat transmission through glass:

Cooling Load [BTU/hr]=Area×factor×Temperature Difference

For glass materials, transmission gain factor=1.13 (BTU/hr·ft²·F)

Area=Area of glass in the vehicle (front-back-side windows)

Temperature Difference=difference between ambient temperature outside (say 113 F (45 C)) and vehicle's interior (say 95 F (35 C)) in Fahrenheit scale.

(2) Load due to heat transmission through vehicle's body:

Cooling Load [BTU/hr]=Area×U-factor×Temperature Difference

For vehicle' body materials, transmission gain factor=0.3 (BTU/hr·ft²·F)

Area=External area of vehicle (excluding glass)

Temperature Difference=difference between ambient temperature outside (say 113 F (45 C)) and vehicle's interior (say 95 F (35 C)) in Fahrenheit scale.

(3) Load due to heat transmission through vehicle's body:

Cooling Load [BTU/hr]=Glass area×Solar factor

For UAE, solar factor=60 (BTU/hr·ft²) (average of all solar directions)

Area=Area of vehicle's glass

Load due to infiltration of hot air through vehicle's body:

4-a) Cooling Load (Sensible load), [BTU/hr]=Volume of air infiltrated×Temperature Difference×1.08

4-b) Cooling Load (latent load), [BTU/hr]=Volume of air infiltrated×Absolute Humidity Difference×0.68

Where, Volume of air infiltrated=Volume of vehicle's cabinet×Air Change per Hour

Air Change per Hour=1

Temperature Difference=difference between ambient temperature outside (say 45 C) and vehicle's interior (say 35 C) in Fahrenheit scale

Absolute Humidity Difference=difference between ambient outside air absolute humidity (say 45 C conditions—worst case) and vehicle's interior (say at 35 C acceptable conditions) in Grains/pound scale.

Overall Cooling Load, [BTU/hr]=Load 1+Load 2+Load 3+Load4-a+Load 4-b

Total Cooling Load=Overall Cooling Load x safety factor of 1.1 (inclusion of 10% extra heat in case of error in calculations)

For typical Vehicle in the UAE; the overall cooling load (amount of heat to be removed from the vehicle cabinet)≈1.75 kilo Watt (kW), or 0.5 TON of Refrigeration.

(II) Calculation of the heat pipe dimensions:

Q (gained by vehicle)=Q (removed by heat pipes' evaporator)

$$\dot{Q} ( Evaporator ) = m \times {h}_{fg} \times ( \frac{1}{time} )$$

### Where:

$$m = ρ \times ⌈ ( \frac{π}{4} ) \times {d}^{2} \times l \times filling ratio ⌉$$

$$\dot{Q} ( Evaporator ) = ρ \times [ ( \frac{π}{4} ) \times {d}^{2} \times l \times filling ratio ] \times {h}_{fg} \times ( \frac{1}{time} )$$

$$So , \\ l = \frac{\dot{Q}}{ρ \times [ ( \frac{π}{4} ) \times {d}^{2} \times filling ratio \times {h}_{fg} \times ( \frac{1}{time} ) ]}$$

m=mass of liquid evaporated inside the heat pipes

ρ=density of liquid (kg/m³)

d=diameter of pipe (m)

I=overall length of heat pipes used to remove the heat

filling ratio=percentage of filling of pipe=volume of liquid inside pipe/volume of all pipe

h_{fg}=later heat of evaporation J/kg

time=time of liquid evaporation (assumed here)

The filling ratio was assumed to be 10%, time to be 10 sec and we took the standard ASME diameter (d) for the copper heat pipe to be 0.75 in. Finally we calculated the total length of the heat pipe in order to find the number of heat pipes that we need.

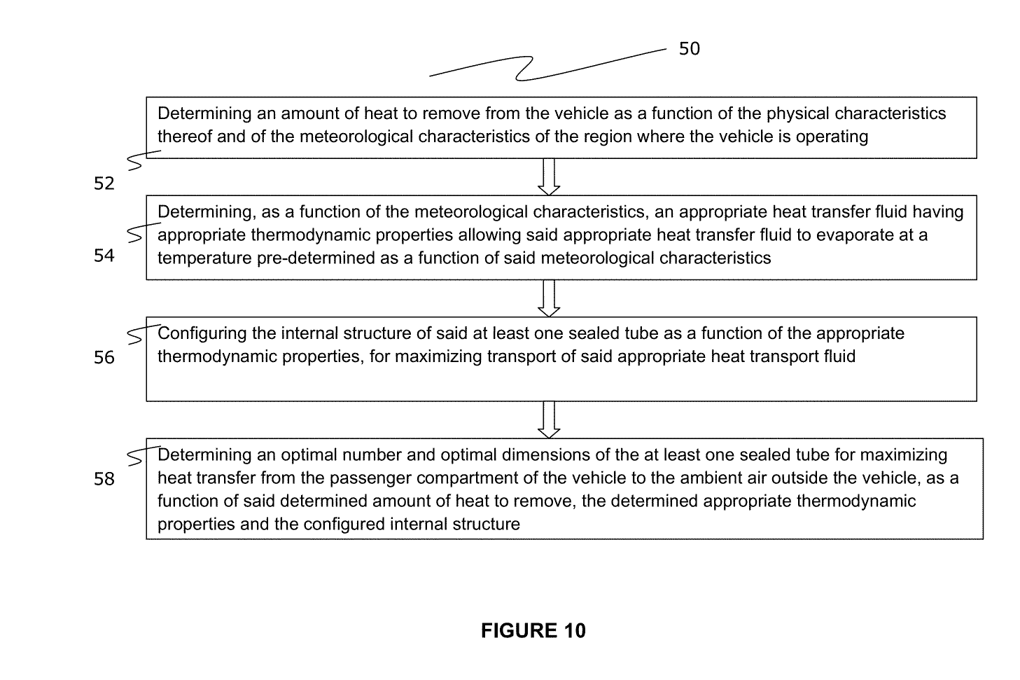

Thus, as illustrated in FIG. 10, the present invention provides for a method of determining an optimal structure of a heat transfer device for transferring heat from the passenger compartment of a vehicle to the ambient air outside the vehicle 50, the vehicle having vehicle physical characteristics and operating in a region having meteorological characteristics, the heat transfer device comprising at least one sealed tube 12 having a proximal end 22 in fluid communication with a distal end 20, a chamber 16 extending from the proximal 22 end to the distal end 20, a heat transport fluid 13 gravitationally biased within the proximal end 22; and an internal structure 10 configured to allow the heat transport fluid to pass from the distal end 20 to the proximal end 22, the proximal end 22 functioning as an evaporator and the distal end 20 functioning as a condenser, the method comprising:
determining an amount of heat to remove from the vehicle as a function of the vehicle physical characteristics and of the meteorological characteristics of the region 52;
determining, as a function of the meteorological characteristics, an appropriate heat transfer fluid, the appropriate heat transfer fluid having appropriate thermodynamic properties allowing the appropriate heat transfer fluid to evaporate at a temperature pre-determined as function of the meteorological characteristics 54;
configuring the internal structure of the at least one sealed tube, as a function of the appropriate thermodynamic properties, for maximizing transport of the appropriate heat transport fluid 56; and
determining an optimal number and optimal dimensions of the at least one sealed tube for maximizing heat transfer from the passenger compartment of the vehicle to the ambient air outside the vehicle, as a function of the determined amount of heat to remove, the determined appropriate thermodynamic properties and the configured internal structure 58.

Preferably, the physical characteristics of the vehicle comprise a body having various components of different material in direct contact with the ambient air, and the determining an amount of heat to remove from the vehicle comprises determining an amount of heat and hot air infiltrated through each one of the various components inside the vehicle.

Preferably, the internal structure 14 has pores and the configuring the internal structure comprises determining an appropriate size of the pores for maximizing transport of the appropriate heat transport fluid 13 between the proximal 22 and distal 20 ends under capillary action.

Preferably, the meteorological characteristics taken into consideration to determine the optimal structure of the device comprise a temperature and a humidity rate of the region where the vehicle is operating.

Preferably, the process of determining optimal dimensions comprises determining an optimal ratio between a diameter of the tube 12 and a thickness of the internal structure 14.

Preferably, the process of determining optimal dimensions further comprises determining an optimal ratio between a diameter of the chamber 16 and a thickness of the internal structure 14.

Preferably, the process of determining optimal dimensions further comprises determining an optimal ratio between a diameter of the tube 12 and a diameter of the chamber 16.

Preferably, the process of determining optimal dimensions also comprises determining an optimal ratio between a diameter of the tube 12 and a length of the tube 12.

Preferably, the process of determining optimal dimensions also comprises determining an optimal ratio between a length of the tube 12 and a diameter of the chamber 16.

Although the above description contains many specificities, these should not be construed as limitations on the scope of the invention but is merely representative of the presently preferred embodiments of this invention. The embodiment(s) of the invention described above is(are) intended to be exemplary Only. The scope of the invention is therefore intended to be limited solely by the scope of the appended claims.

1. A method of determining an optimal structure of a heat transfer device for transferring heat from the passenger compartment of a vehicle to the ambient air outside said vehicle, said vehicle having vehicle physical characteristics and operating in a region having meteorological characteristics, said heat transfer device comprising at least one sealed tube having a proximal end in fluid communication with a distal end, a chamber extending from the proximal end to the distal end, a heat transport fluid gravitationally biased within the proximal end; and an internal structure configured to allow the heat transport fluid to pass from the distal end to the proximal end, said proximal end functioning as an evaporator and said distal end functioning as a condenser, the method comprising:
determining an amount of heat to remove from said vehicle as a function of said vehicle physical characteristics and of said meteorological characteristics of said region;
determining, as a function of said meteorological characteristics, an appropriate heat transfer fluid, said appropriate heat transfer fluid having appropriate thermodynamic properties allowing said appropriate heat transfer fluid to evaporate at a temperature pre-determined as a function of said meteorological characteristics;
configuring said internal structure of said at least one sealed tube, as a function of said appropriate thermodynamic properties, for maximizing transport of said appropriate heat transport fluid; and
determining an optimal number and optimal dimensions of said at least one sealed tube for maximizing heat transfer from said passenger compartment of said vehicle to said ambient air outside said vehicle, as a function of said determined amount of heat to remove, said determined appropriate thermodynamic properties and said configured internal structure.

2. The method as claimed in claim 1, wherein said physical characteristics of said vehicle comprise a body having various components of different material in direct contact with said ambient air, and said determining an amount of heat to remove from said vehicle comprises determining an amount of heat and hot air infiltrated through each one of said various components inside said vehicle.

3. The method as claimed in claim 2, wherein said internal structure has pores and said configuring said internal structure comprises determining an appropriate size of said pores for maximizing transport of said appropriate heat transport fluid between said proximal and distal ends under capillary action.

4. The method as claimed in claim 3, wherein said meteorological characteristics comprise a temperature and a humidity rate.

5. The method as claimed in claim 3, wherein said determining optimal dimensions comprises determining an optimal ratio between a diameter of said tube and a thickness of said internal structure.

6. The method as claimed in claim 3, wherein said determining optimal dimensions comprises determining an optimal ratio between a diameter of said channel and a thickness of said internal structure.

7. The method as claimed in claim 3, wherein said determining optimal dimensions comprises determining an optimal ratio between a diameter of said tube and a diameter of said chamber.

8. The method as claimed in claim 3, wherein said determining optimal dimensions comprises determining an optimal ratio between a diameter of said tube and a length of said tube.

9. The method as claimed in claim 3, wherein said determining optimal dimensions comprises determining an optimal ratio between a length of said tube and a diameter of said chamber.

10. A heat transfer device for transferring heat from the passenger compartment of a vehicle to the ambient air outside said vehicle, the device comprising:
a sealed tube having a proximal end in fluid communication with a distal end;
a chamber extending from the proximal end to the distal end;
a heat transport fluid, gravitationally biased within the proximal end; and
an internal structure configured to allow the heat transport fluid to pass from the distal end to the proximal end.

11. The heat transfer device as claimed in claim 10, wherein the device is configured to enable the heat transport fluid to pass from the distal end to the proximal end under capillary action.

12. The heat transfer device according to claim 10, wherein the proximal end functions as an evaporator and the distal end functions as a condenser.

13. The heat transfer device according to claim 10, wherein the tube diameter is at least 6 times greater than the thickness of the internal structure.

14. The heat transfer device according to claim 10, wherein the diameter of the channel is at least 3 times greater than the thickness of the internal structure.

15. The heat transfer device according to claim 10, wherein the tube diameter is at least 2 times greater than the diameter of the chamber.

16. The heat transfer device according to claim 10, wherein the length of the tube is at least 20 times the greater than the tube diameter.

17. The heat transfer device according to claim 10, wherein the length of the tube is at least 40 times the greater than the chamber diameter.

18. The heat transfer device according to claim 10, wherein the tube is substantially circular in cross-section.

19. The heat transfer device according to claim 10, wherein the heat transport fluid is Diethyl ether (DEE).

20. The heat transfer device according to claim 10, wherein the tube diameter is less than 0.025 m.

21. The RAH heat transfer device according to claim 10, wherein the porosity of the internal structure is 0.25 or greater.
